(19) United States
(12) Patent Application Publication
(10) Pub. No.: US 2006/0006793 A1
(43) Pub. Date: Jan. 12, 2006

(54) Deep ultraviolet used to produce white light

(76) Inventors: Tajul Arosh Baroky, Penang (MY); Janet Bee Yin Chua, Penang (MY); Kheng Leng Tan, Penang (MY); Kok Chin Pan, Penang (MY); Kee Yean Ng, Prai Penang (MY)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/889,244

(22) Filed: Jul. 12, 2004

(51) Int. Cl. H01J 1/62; H01J 63/04

(52) U.S. Cl. 313/502

(57) ABSTRACT

A light-generating device includes a light-emitting device emitting light with a wavelength in the range of 160 nm to 290 nm. White light emitting phosphor material is placed in proximity of the light-emitting device.

### BACKGROUND

A conventional single chip light-emitting diode (LED) emits a monochromatic color with high purity. Typical colors emitted are pure blue, pure green, pure yellow or pure red. A white LED is produced by incorporating a photoluminescent material called phosphor together with the LED chip.

Typically to produce white light a blue InGaN LED is used with yttrium-aluminum-garnet (YAG) based phosphors, variations of YAG based phosphors, terbium-yttrium-aluminum-garnet based phosphors or variations of terbium-yttrium-aluminum-garnet based phosphors. The peak wavelength emitted for the blue LEDs typically range from 460 nanometers (nm) to 480 nm.

### SUMMARY OF THE INVENTION

In accordance with embodiments of the present invention, a light-generating device includes a light-emitting device emitting light with a wavelength in the range of 160 nm to 290 nm. White light emitting phosphor material is placed in proximity of the light-emitting device.

### BRIEF DESCRIPTION OF THE DRAWINGS

FIG. 1 shows a P-up type die configuration for a deep UV light-emitting device as used with an embodiment of the present invention.

FIG. 2 shows a P-N type die configuration for a deep UV light-emitting device as used with an embodiment of the present invention.

FIG. 3 shows a P-N flip chip type die configuration for a deep UV light-emitting device as used with an embodiment of the present invention.

FIG. 4 shows a white light source that includes a light-emitting device, surrounded by an epoxy that includes phosphor, packaged as a through-hole lamp in accordance with an embodiment of the present invention.

FIG. 5 shows a white light source that includes a deep UV light-emitting device, surrounded by an epoxy that includes phosphor, shown used in a high power printed circuit board (PCB) surface mount application in accordance with another embodiment of the present invention.

FIG. 6 shows a white light source that includes a deep UV light-emitting device, surrounded by an epoxy that includes phosphor, packaged in a lead frame surface mount application in accordance with another embodiment of the present invention.

FIG. 7 shows a white light source that includes a deep UV light-emitting device, surrounded by an epoxy that includes phosphor, mounted within a PCB in accordance with another embodiment of the present invention.

### DESCRIPTION OF THE EMBODIMENT

In disclosed embodiments of the present invention, deep ultraviolet (UV) light-emitting diodes (LEDs) that emit light with a wavelength in the range of 160 nm to 290 nm and a typical maximum LED chip output of 50 milliwatts, used in conjunction with phosphor material, emit an efficient white light. The use of deep UV provides good color point repeatability and an excellent color rendering index (CRI) of greater than 90. The use of deep Uw also allows better color matching for the white light emitted.

In various embodiments of the present invention, a deep UV solid state semiconductor chip is mounted in a cavity in a substrate with a reflective surface. A phosphor material is placed in direct contact or proximity with the light-emitting surface. The light emitted from the chip substrate passes thru the phosphor interface, where the emitted deep UV wavelength is used to excite the phosphor material to produce a secondary emission of white light. The phosphor material can be placed in contact with the Deep UV LED in a coated form, dispersed in a matrix or colloidal paste or a powder conformably coated. The solid state semiconductor deep UV LED can be a single or plurality of chips in a P-up, N-up, P-up and N-up (P-N) or flip chip type die configuration with the reflecting mirror either below or above the emitting active layer depending on the orientation of the emitting active layer. The wavelength emitted by the deep UV LED may range from 160 nm through 290 nm.

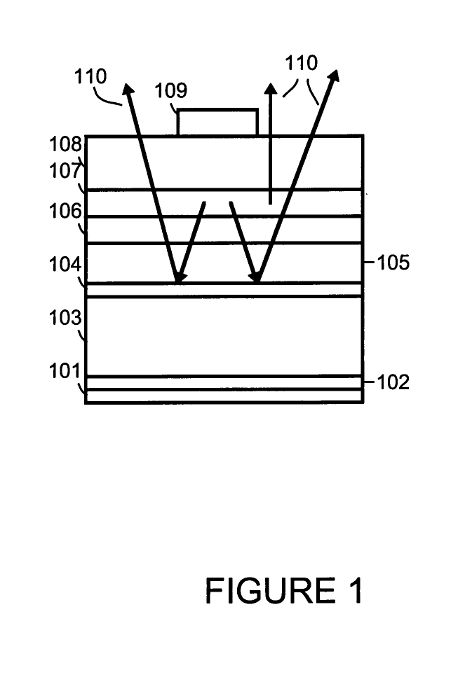

FIGS. 1 through 3 illustrate the variety of die configurations for deep UV LEDs. These are meant to be illustrative of the wide applicability of the present invention in various configurations, and are not meant to be limiting of the scope of the present invention. For more description on die configurations, see for example, G. B. Stringfellow & M. George Crawford, “High Brightness Light Emitting Diodes”, Semiconductors and Semimetals, vol. 48, Academic Press, 1997.

FIG. 1 shows a P-up type die configuration for a deep UV light-emitting device. A layer 101 is composed of N-type contact material. For example, layer 101 is composed of gold-zinc (Au—Zn). A layer 102 is a buffer tie layer. A layer 103 is, for example, an N-doped layer consisting of gallium-nitrogen (GaN) and is, for example, approximately 100 to 180 micrometers (μm) thick. A layer 104 forms a Bragg refractor. For example, layer 104 is approximately 1.5 to 2.0 nanometers (nm) thick. A layer 105 is, for example, an N-doped layer consisting of GaN. A layer 106 is an N-doped layer approximately 15 to 20 μm thick. A layer 107 is, for example, an active layer. For example, layer 107 is approximately 2 to 20 nanometers thick. A layer 108 is, for example, a P-doped layer of GaN. For example, layer 108 is 30 to 50 μm thick. For example, region 109 is composed of P-contact metal such as nickel-gold (Ni—Au) or aluminum (Al). Arrows 110 show illustrative light paths.

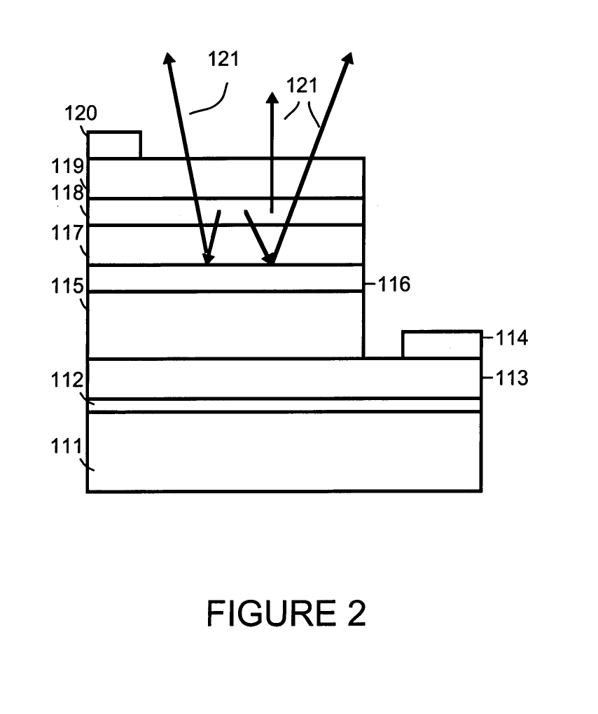

FIG. 2 shows a P-up and N-up (P-N) type die configuration for a deep UV light-emitting device. A layer 111 is a substrate of variable thickness and composed of, for example, silicon. A layer 112 is a buffer tie layer. A layer 113 is, for example, an N-doped layer consisting of GaN. Region 114 is composed of N-contact metal material such as titanium-aluminum (Ti—Al) or Au—Zn. A layer 115 is, for example, an N-doped layer consisting of GaN and is, for example, approximately 100 to 180 micrometers (μm) thick. A layer 116 forms a Bragg refractor. For example, layer 116 is approximately 1.5 to 2.0 nanometers (nm) thick. A layer 117 is an N-doped layer approximately 15 to 20 μm thick. A layer 118 is, for example, an active layer. For example layer 118 is approximately 2 to 20 nanometers thick. A layer 119 is, for example a P-doped layer of GaN. For example, layer 119 is 30 to 50 μm thick. Region 120 is composed of P-contact metal such as nickel-gold (Ni—Au) or gold-germanium (Au—Ge). Arrows 121 show illustrative light paths.

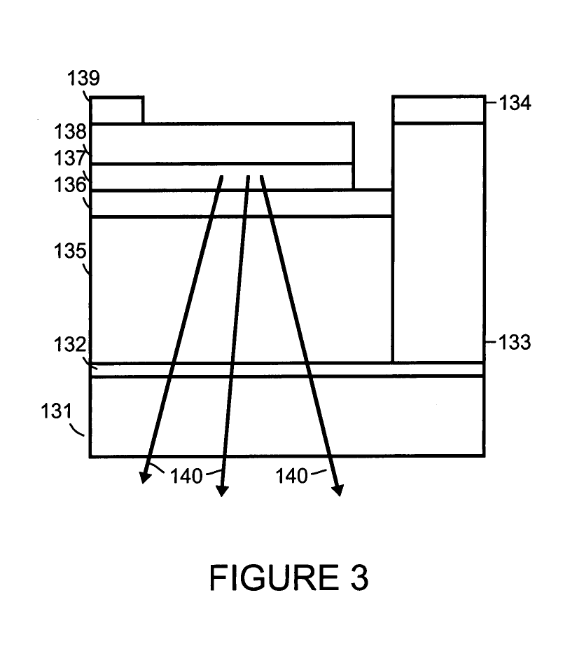

FIG. 3 shows a P-up and N-up (P-N) which is also a flip chip type die configuration for a deep UV light-emitting device. A layer 131 is a substrate of variable thickness and composed of, for example, sapphire. A layer 132 is a buffer tie layer. A layer 133 is, for example, an N-doped layer consisting of GaN. Region 134 is composed of N-contact metal material such as Ti—Al or Au—Zn. A layer 135 is, for example, an N-doped layer consisting of GaN and is, for example approximately 100 to 180 micrometers (μm) thick. A layer 136 is an N-doped layer approximately 15 to 20 μm thick. A layer 137 is, for example, an active layer. For example layer 137 is approximately 2 to 20 nanometers thick. A layer 138 is, for example, a P-doped layer of GaN. For example, layer 138 is 30 to 50 μm thick. Region 139 is composed of P-contact metal such as Ni—Au or Au—Ge. Arrows 140 show illustrative light paths.

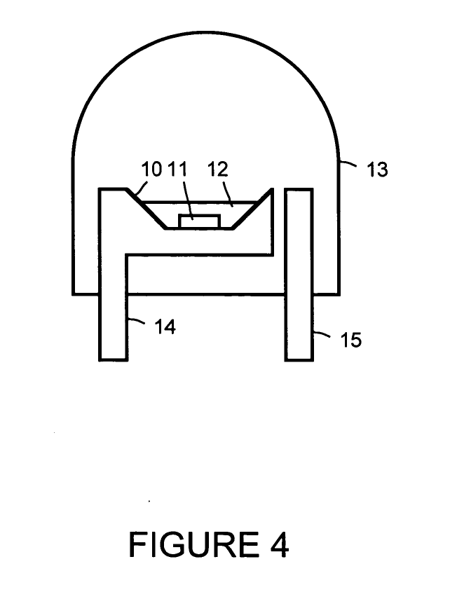

FIG. 4 shows a through-hole lamp that includes a liquid encapsulation epoxy 13, a pin 14 and a pin 15. A light-emitting device 11 is mounted within a reflective cup area 10 of the through-hole lamp. Light-emitting device 11 is covered by an epoxy 12 that includes phosphor material. For example, epoxy 12 is a liquid epoxy that includes a YAG based phosphor, a variation of YAG based phosphor, a terbium-aluminum-garnet (TAG) based phosphors or a variation of TAG based phosphors. Other phosphor blends may also be used. See, for example, U.S. Pat. No. 6,621,211 B1. For example light-emitting device 11 is a deep UV light-emitting diode (LED) that emits light with a wavelength within a range of 160 nm to 290 nm. Alternatively, the phosphor material may be located in other locations, such as somewhere within encapsulation epoxy 13 or on a shell surrounding encapsulation epoxy 13.

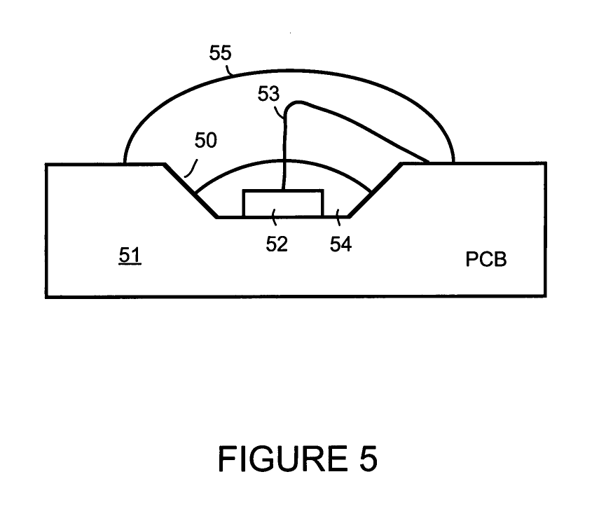

FIG. 5 shows a light-emitting device 52 placed in a surface mount configuration within a reflective cup area 50 of a PCB 51. A wire 53 is connected between light-emitting device 52 and PCB 51. Epoxy 54 includes phosphor material. For example, epoxy 54 is a liquid epoxy that includes a YAG based phosphor, a variation of YAG based phosphors, a TAG based phosphor or a variation of TAG based phosphors. Other phosphor blends may also be used. A mold compound 55 is placed over epoxy 54. For example, light-emitting device 52 is a deep UV light-emitting diode (LED) that emits light with a wavelength within a range of 160 nm to 290 nm.

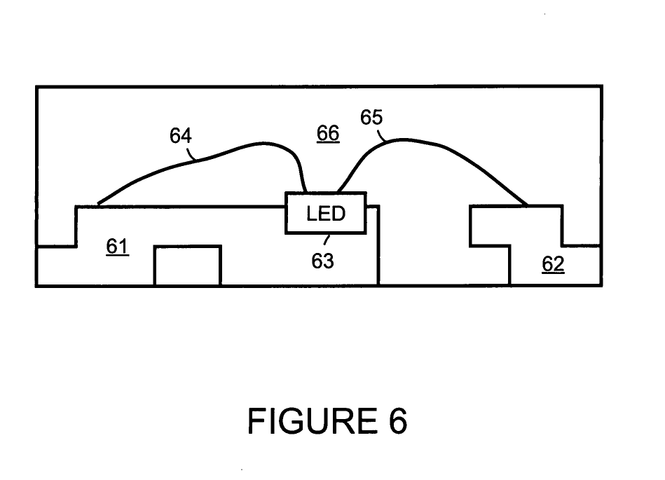

FIG. 6 shows a light-emitting device 63 placed in a surface mount configuration on a leadframe portion 61. A wire 64 is connected between light-emitting device 63 and leadframe portion 61. A wire 65 is connected between light-emitting device 63 and a leadframe portion 62. Epoxy 66 includes phosphor material. For example, epoxy 66 is a liquid epoxy that includes a YAG based phosphor, a variation of YAG based phosphors, a TAG based phosphor or a variation of TAG based phosphors. Other phosphor blends may also be used. For example, light-emitting device 63 is a deep UV light-emitting diode (LED) that emits light with a wavelength within a range of 160 nm to 290 nm.

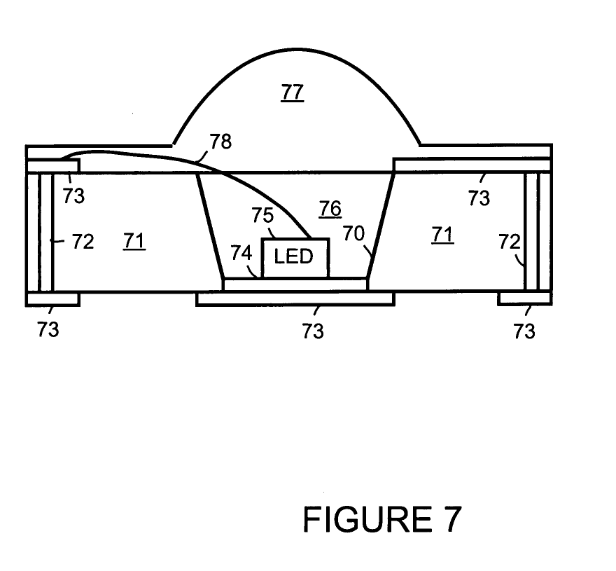

FIG. 7 shows a light-emitting device 75 mounted on a heat sink 74 within a reflective cup area 70 of a PCB substrate 71. Vias 72 through PCB substrate 71 make connections between contacts 73. A wire 78 is connected between light-emitting device 75 and contacts 73, as shown. Epoxy 76 and/or encapsulation epoxy 77 include phosphor material. For example, epoxy 76 is a YAG based phosphor, a variation of YAG based phosphors, a TAG based phosphor or a variation of TAG based phosphors. Other phosphor blends may also be used. For example, light-emitting device 75 is a deep UV light-emitting diode (LED) that emits light with a wavelength within a range of 160 nm to 290 nm.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A light-generating device comprising:
a light-emitting device emitting light with a wavelength in the range of 160 nm to 290 nm; and,
white light emitting phosphor material in proximity of the light-emitting device.

2. A light-generating device as in claim 1 wherein the light-emitting device includes a solid state semiconductor chip mounted in a cavity in a substrate with a reflective surface.

3. A light-generating device as in claim 1 wherein the phosphor material is in one of the following forms:
coated;
dispersed in a matrix;
dispersed in a colloidal paste;
in a powder conformally coated.

4. A light-generating device as in claim 1 wherein the light-emitting device includes a solid state semiconductor chip in one of the following configurations:
P-up;
N-up;
P-up and N-up;
flip chip.

5. A light-generating device as in clam 1 wherein the white light emitting phosphor material is in contact with the light-emitting device.

6. A light-generating device comprising:
a light-emitting means for emitting light with a wavelength in the range of 160 nm to 290 nm; and,
white light emitting means for receiving the emitting light with the wavelength in the range of 160 nm to 290 and emitting a white light.

7. A light-generating device as in claim 6 wherein the light-emitting means comprises a solid state semiconductor chip mounted in a cavity in a substrate with a reflective surface.

8. A light-generating device as in claim 6 wherein the white light emitting means is phosphor material in one of the following forms:
coated;
dispersed in a matrix;
dispersed in a colloidal paste;
in a powder conformally coated.

9. A light-generating device as in claim 6 wherein the light-emitting means comprises a solid state semiconductor chip in one of the following configurations:
P-up;
N-up;
P-up and N-up;
flip chip.

10. A light-generating device as in clam 6 wherein the white light emitting means is in contact with the light-emitting means.

11. A method for generating white light comprising:
emitting light with a wavelength in the range of 160 nm to 290 nm; and,
receiving the emitting light with the wavelength in the range of 160 nm to 290 by phosphor material and emitting white light from the phosphor material.

12. A method as in claim 11 wherein the light with the wavelength in the range of 160 nm to 290 nm is emitted from a solid state semiconductor chip mounted in a cavity in a substrate with a reflective surface.

13. A method as in claim 11 wherein the phosphor material is in one of the following forms:
coated;
dispersed in a matrix;
dispersed in a colloidal paste;
in a powder conformally coated.

14. A method as in claim 11 wherein the light with the wavelength in the range of 160 nm to 290 nm is emitted from a solid state semiconductor chip in one of the following configurations:
P-up;
N-up;
P-up and N-up;
flip chip.
